(19) United States
(12) Patent Application Publication
(10) Pub. No.: US 2009/0308061 A1
(43) Pub. Date: Dec. 17, 2009

(54) Cangrier-M1 machine or C-M1 the powerful miracle perpetual motion machine designed for hydroelectric power generation water recycling concept

(75) Inventor: Edgardo Co Timcang, SR., Las Pinas City (PH)

Correspondence Address: Miss Mary Grace Soriano Timcang, 2262 Garnet Drive, Vallejo, CA, 94591, US

(73) Assignee: Miss Mary Grace Timcang, Vallejo, CA (US)

(21) Appl. No.: 12/231,697

(22) Filed: Sep. 6, 2008

Related U.S. Application Data
(60) Provisional application No. 61/071,666, filed on Jun. 17, 2008.

(51) Int. Cl. F03B 17/04; H02K 53/00

(52) U.S. Cl. 60/325; 74/DIG. 9

(57) ABSTRACT

When water is pumped manually to the overhead tank, the weight of the water is felt on the opposite end of the lever. Thus, an equal or heavier weights to counter that weight is thought of. This idea works on the output process but not on the input process. However, unlike conventional water pumps, C-M1 works on both processes using techniques (the invention) that employ the underlying principle of equilibrium or perfect balance. These techniques have resulted to the discovery of C-M1, a very powerful perpetual motion machine capable of using equal or heavier weights to counter the weights on the other end of the lever on both the input and output operations. Therefore, since it is perfectly balance, pumping out 1 cubic meter of 10 water per stroke through a 1.6-meter diameter 500-meter high pipe, with a total water weight of 1,000 tons, is simple and easy job for C-M1.

### BACKGROUND OF THE INVENTION

My quest for a machine that runs without the need of any fossil fuel, nuclear, or any prime mover that needs consumable materials or elements, started in August 1970 in my Earth Science subject. It started when one of my classmates raised the question on how to control air, water and noise pollution and radiation. Then somebody answered: “Ma'am, through perpetual motion machine!”. Thenceforth, my research and study for that elusive machine has been born and intensified. Time, effort, and money were all focused on how to discover such machine. I have also read and heard about perpetual motion machines run by gravity, spring, flywheel, magnet, electromagnet, but all are bulky and impractical. I concentrated on known renewable energies as well, but all have drawbacks and limitations. Because of these imperfections, my research and experiment persisted. I continued such endeavor when I worked in Bahrain and Saudi Arabia, and when I was back to the Philippines. Sometime in early 1980s, I became interested in water pumps. I devoted myself on studying it extensively. Then, suddenly, in mid 1980s, the first clue came flashing into my mind. If the weight of the water inside the pipe that is from the tip of the piston all the way up to the tip of the pipe is counterbalanced by the same weight on the other end of the lever, then pumping out such weight of water (Output/Discharge Operation) can be made even through the tip of my finger. But how about the water intake (Input/Intake Operation) where the piston draws water from the supply source where, in such operation, the valve is closed? The same problem will occur! Only this time, the problem is shifted to the counterweight instead of the weight of the water inside the system. How can we solve this problem? This is precisely the reason why C-M1 has been discovered and invented.

### BRIEF SUMMARY OF THE INVENTION

In general, the principle and concept of C-M1 is basic of all basics. It adapts the underlying principle of equilibrium where a lever is used to pump water. However, C-M1, unlike ordinary water pumps, employs Techniques (the invention) that have not been discovered since time immemorial. These techniques made C-M1 the most powerful machine ever invented and the most amazing discovery is that it is a perpetual motion machine! The saying that “I can lift a mountain through the tip of my finger” is no longer an exaggeration but a reality. Pumping out water or any liquid, no matter how heavy, high or deep, can be easily done by C-M1. How? By applying the Techniques and the underlying Principle of Equilibrium on both operations: the Input/Intake Operation and the Output/Discharge Operation—the secret of C-M1, which will solve the grave and infinite energy requirements of mankind through hydroelectric power generation water recycling concept here on earth (and, in the immediate future, C-M3, the compact design of C-M1, which will replace the fossil fuel based prime movers and can be used in outer space).

C-M1 is by far incomparable to known conventional prime movers. C-M1, unlike fossil fuel base engines and nuclear power plant, does not pollute air and water. It does not produce sound, heat, smoke, waste, and radiation. Therefore, it does not contribute to air, water, and noise pollution and global warming. It does not cause fire and explosion because it uses only water. Therefore, it is 100% safe to mankind. Compared to known renewable energies such as hydro, geothermal, solar, wind, sea wave, and sea current, all of which have drawbacks, C-M1 does not have any from its power source, which is gravity because it is consistent. Moreover, compared to a hydroelectric having the same capacity, it is 40% to 60% cheaper and 6 to 7 times faster to build when it comes to power generation. Since it is a low RPM machine and has 7 about moving parts, it can even last for a century without breakdown. Therefore, blackouts and brownouts are minimized. Because C-M1 is a noise-free machine, it can be built within a city or urban area. Due to this, expensive pylons, transmission lines and equipments can be minimized or eliminated.

### BRIEF DESCRIPTION OF THE SEVERAL VIEWS OF DRAWINGS

To preclude obstruction of the view of the C-M1 machine's parts specifically the vital parts, and moreover, to visualize clearly the operation and the workability of C-M1, the frame, platform, and foundation are not drawn and some parts are rearranged but do not necessarily affect the efficiency of the overall performance of C-M1.

Actually the drawings expound only on how C-M1 works using the Techniques and Principle of Equilibrium and not on how the discharged water drives the Turbine 9C. Using C-M1 in Hydroelectric Power Generation is just among its many uses. Regardless of the height of the Output Pipe 6E, the same (drawing) structure can be used in irrigation, water supply, cooling system, conveyor, elevator, cable car, and many more.

### A) C-M1 The Machine in Perspective

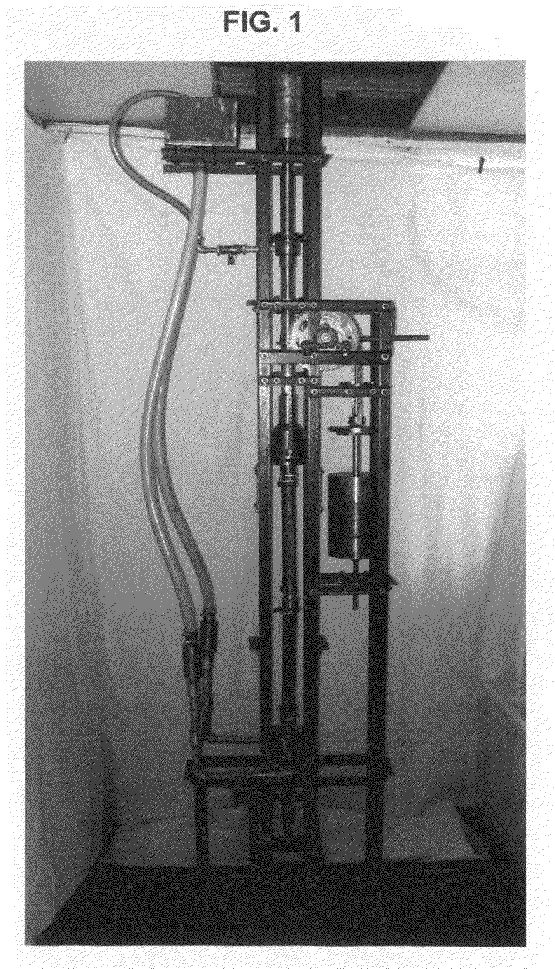

FIG. 1 The Picture of C-M1—the picture depicts the prototype of C-M1. The model is capable of pumping out 70 cc of water per stroke to a height of 1,000 feet using a 1 inch pipe with an estimated water weight of 160 kilos, yet a five year old boy can simply operate it. Since the height is impractical for demonstration, C-M1 is converted into hydraulic form using steel weights instead of water.

Please note that on the top of the machine is a solid-steel. This steel weighs 40 kilos representing the weight of the water inside a 254-feet, 2.6-centimeter diameter pipe.

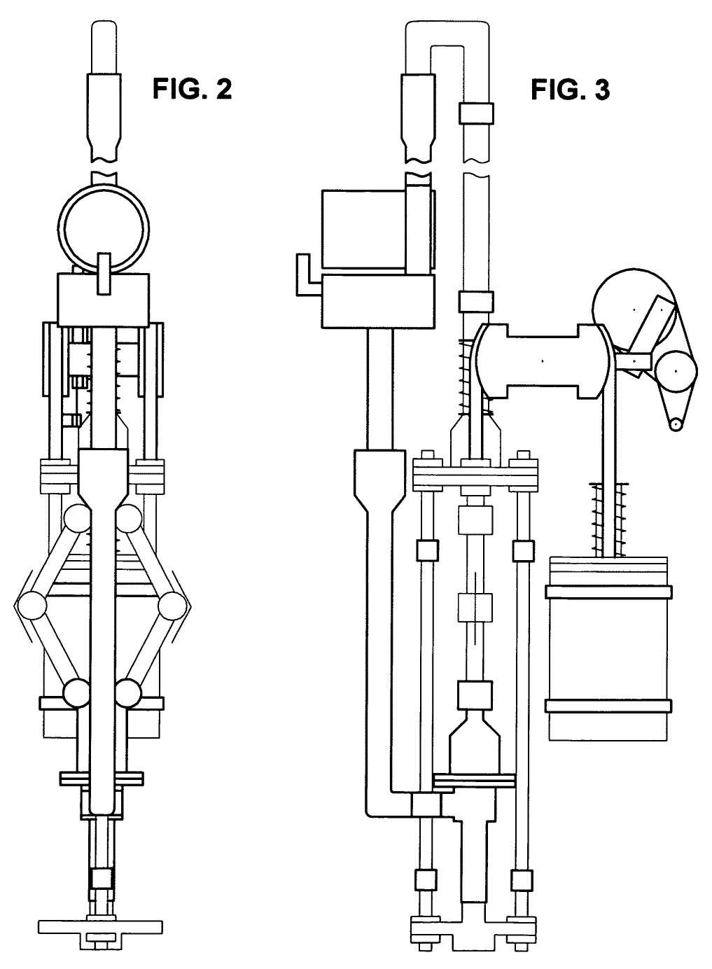

FIG. 2 The Front View of C-M1—depicts the Front View of the non-labeled parts of C-M1.

FIG. 3 The Left Side View of C-M1—depicts the Left Side View of the non-labeled parts of C-M1.

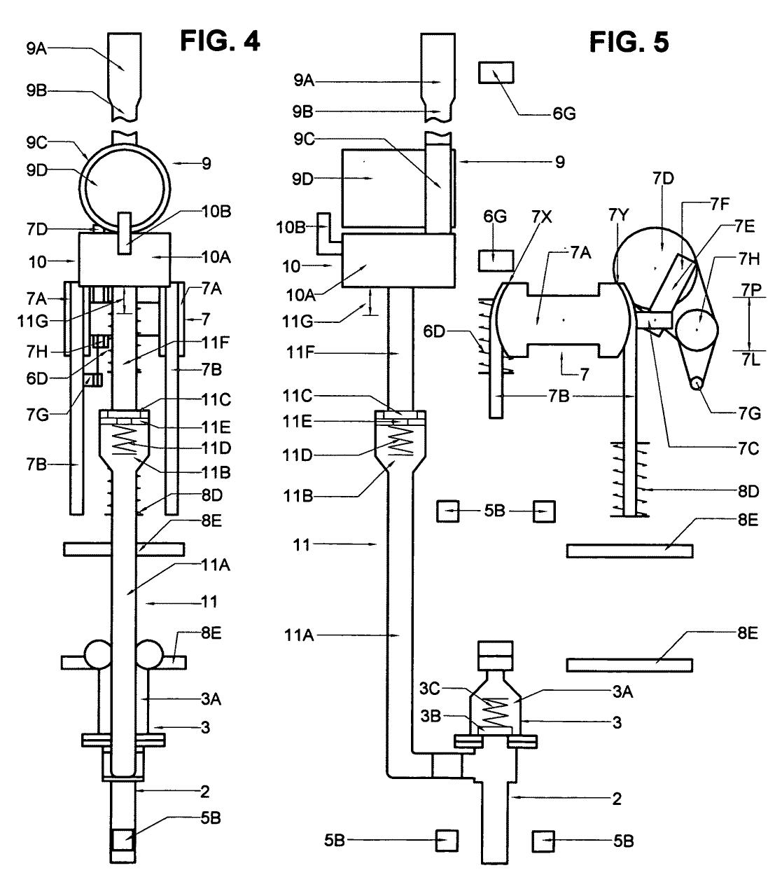

FIG. 4 The Front View of the Non-Moving Component A with Part Number—depicts all labeled parts of the Non-Moving Component A of the machine that are not clearly shown in the Left Side View position.

FIG. 5 The Left Side View of the Non-Moving Component A with Part Number—depicts all labeled parts of the Non-Moving Component A of the machine in a side view position and shows clearly the Lever Assembly 7, Electric Generating Assembly 9 and the Intake Assembly 11.

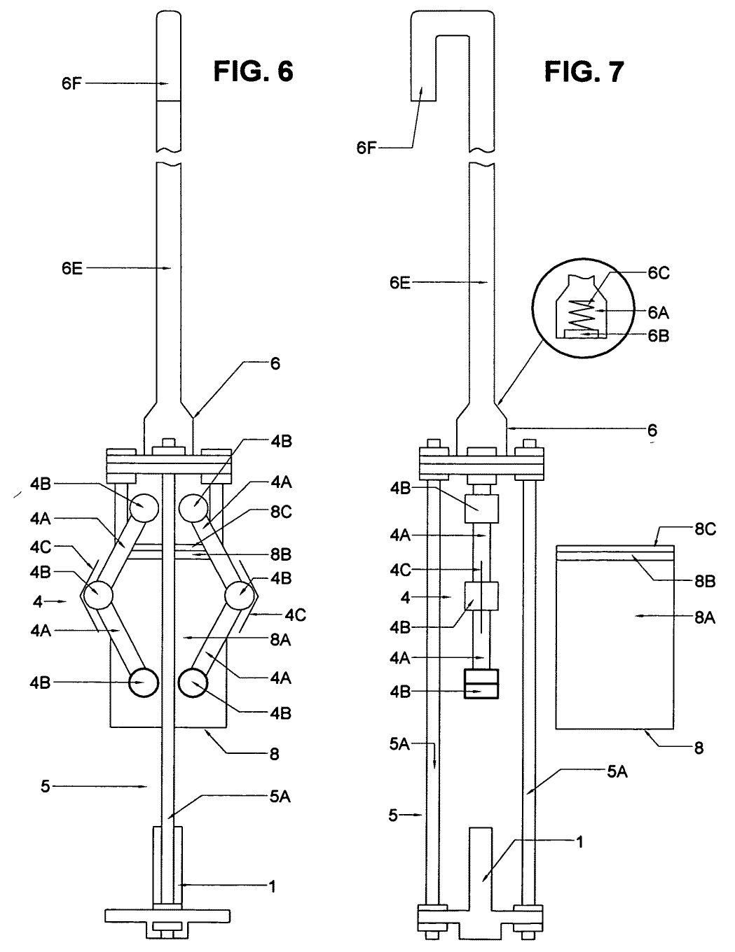

FIG. 6 The Front View of the Moving Component B with Part Number—depicts all labeled parts of the Moving Component B of the machine that are not clearly shown in the Left Side View position.

FIG. 7 The Left Side View of the Moving Component B with Part Number—depicts all labeled parts of the Non-Moving Component B of the machine in a side view position and shows clearly the Transit Pipe Assembly 4 and the Counterweight Assembly 8.

### B) C-M1 During the Output/Discharge Operation

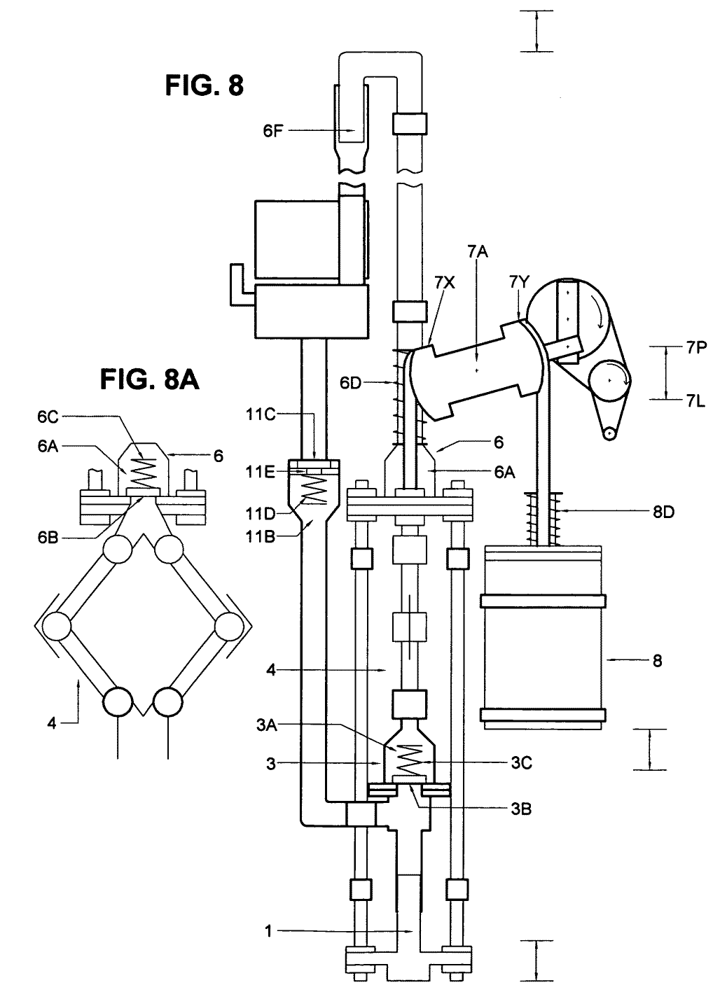

FIG. 8 The Start Position of Output/Discharge Process (or End Position of Input/Intake Operation)—depicts the starting position of C-M1 in the Output/Discharge Operation.

FIG. 8A The Output Chamber Assembly 6 and the Transit Pipe Assembly 4—depicts the front views of the Output Chamber Assembly 6 and the Transit Pipe Assembly 4 at the start of the Output/Discharge Operation.

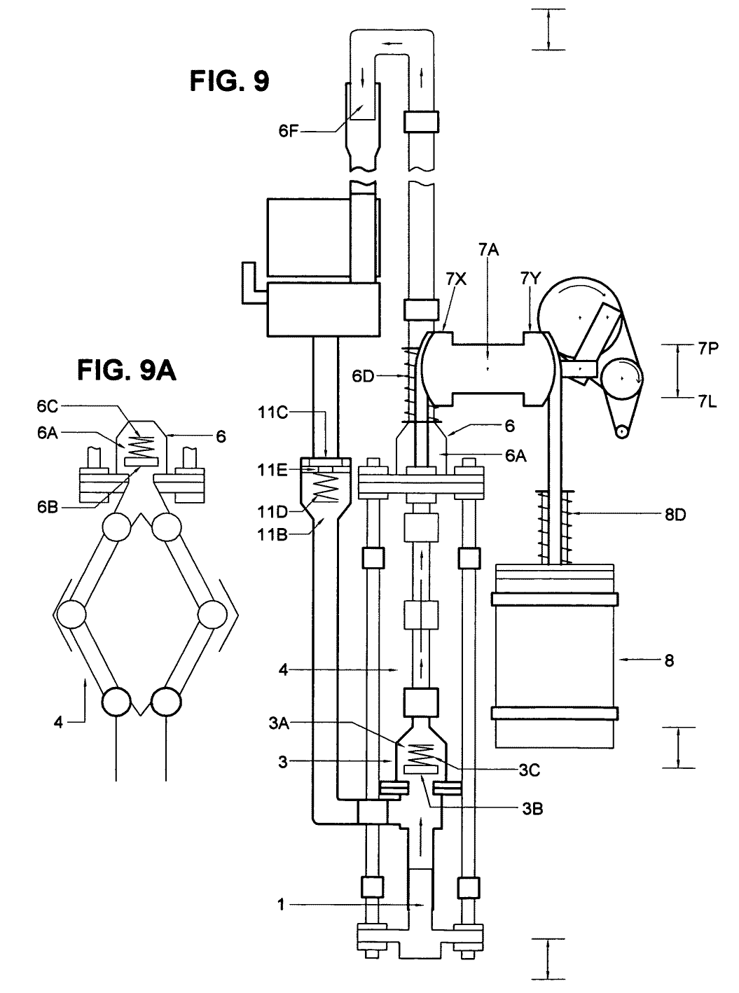

FIG. 9 The Output/Discharge Process—depicts how C-M1 works during Output/Discharge Operation especially the movement of the Moving Component B, Lever Assembly 7, Transit Pipe Assembly 4, Counterweight Assembly 8 and Valves and Springs.

FIG. 9A The Output Chamber Assembly 6 and the Transit Pipe Assembly 4—depicts the front views of the Output Chamber Assembly 6 and the Transit Pipe Assembly 4 during the continuing process of the Output/Discharge Operation.

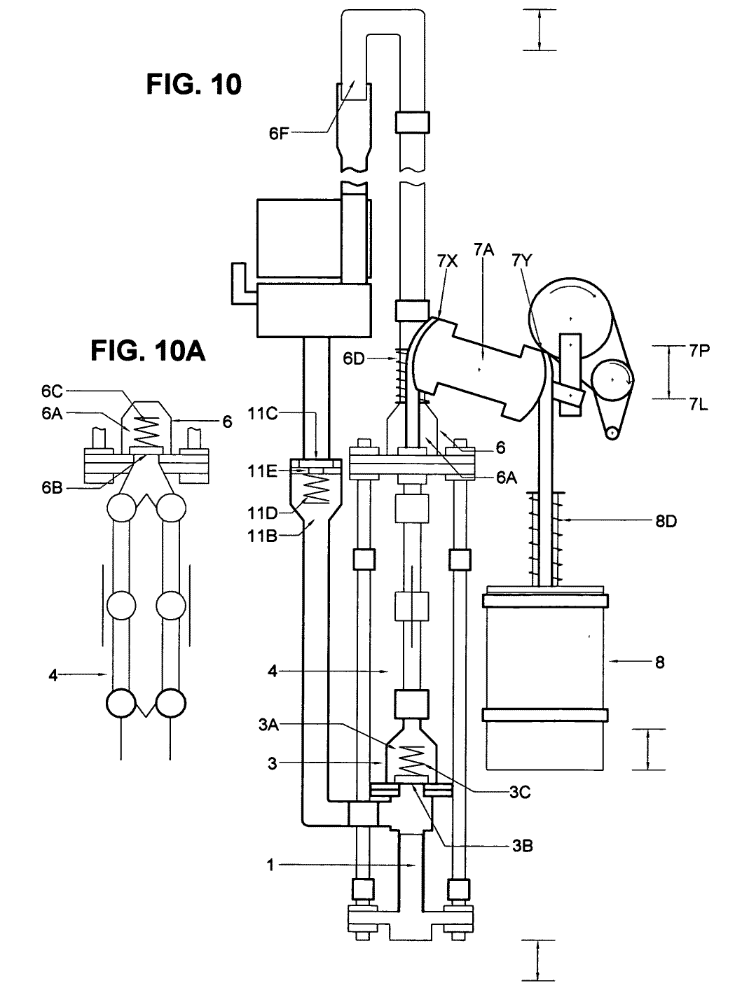

FIG. 10 The End Position of Output/Discharge Process (or Start Position of Input/Intake Operation)—depicts the ending position of C-M1 in the Output/Discharge Operation.

FIG. 10A The Output Chamber Assembly 6 and the Transit Pipe Assembly 4—depicts the front views of the Output Chamber Assembly 6 and the Transit Pipe Assembly 4 during the end process of the Output/Discharge Operation.

### C) C-M1 During the Input/Intake Operation

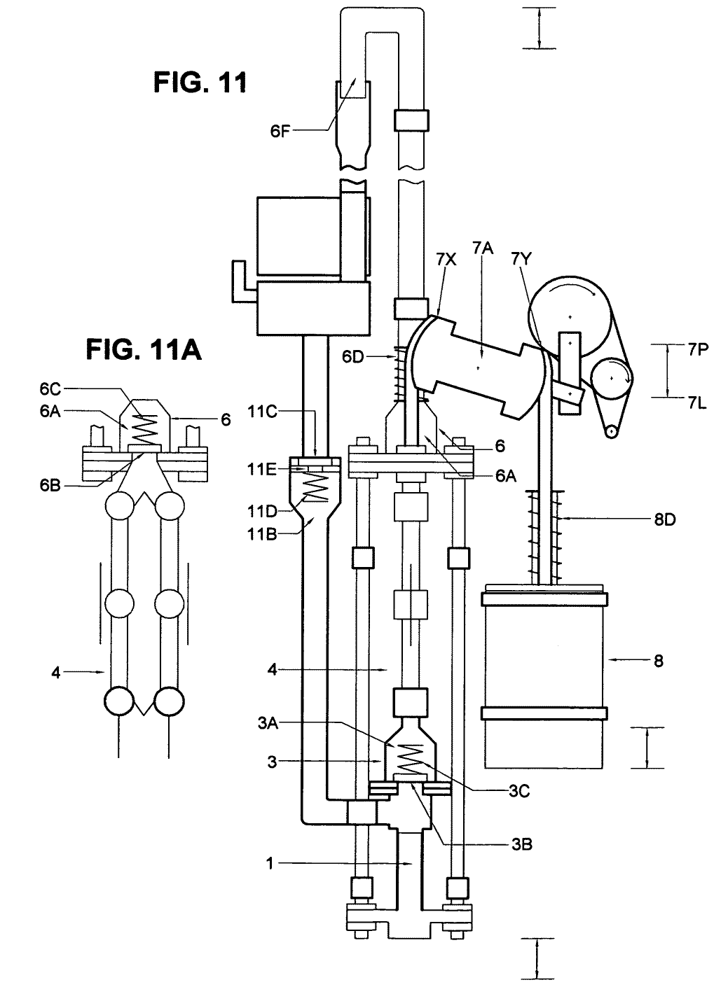

FIG. 11 The Start Position of Input/Intake Process (or End Position of Output/Discharge Operation)—depicts the starting position of C-M1 in the Input/Intake Operation

FIG. 11A The Output Chamber Assembly 6 and the Transit Pipe Assembly 4—depicts the front views of the Output Chamber Assembly 6 and the Transit Pipe Assembly 4 at the start of the Input/Intake Operation.

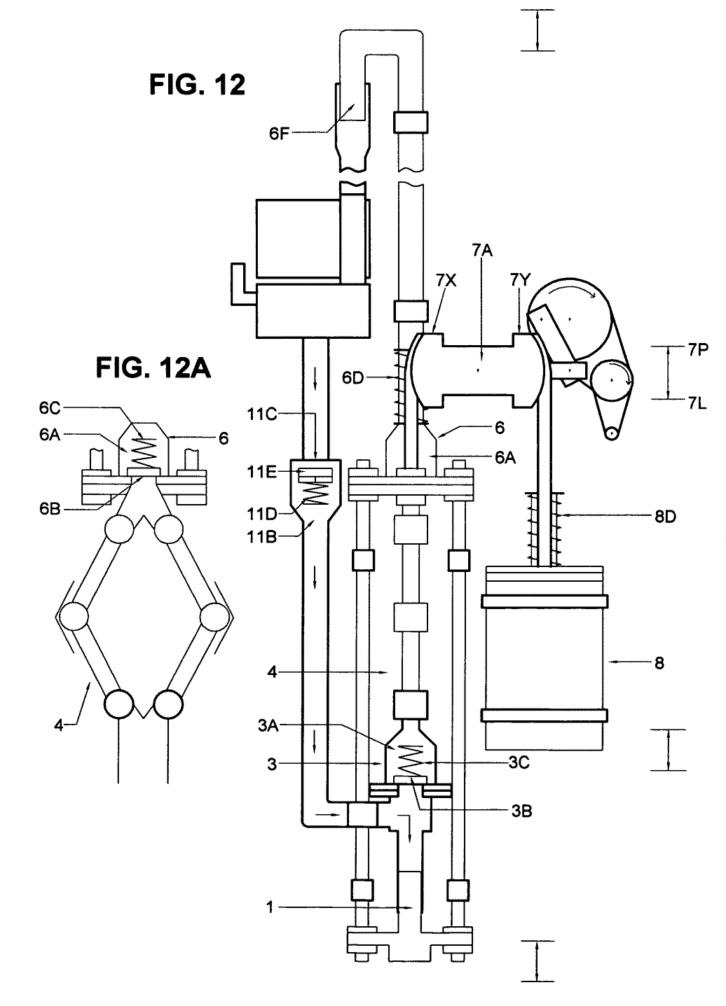

FIG. 12 The Input/Intake Process—depicts how C-M1 works during the Input/Intake Operation especially the movement of the Moving Component B, Lever Assembly 7, Transit Pipe Assembly 4, Counter Weight Assembly 8, and Valves and Springs.

FIG. 12A The Output Chamber Assembly 6 and the Transit Pipe Assembly 4—depicts the front views of the Output Chamber Assembly 6 and the Transit Pipe Assembly 4 during the continuing process of Input/Intake Operation.

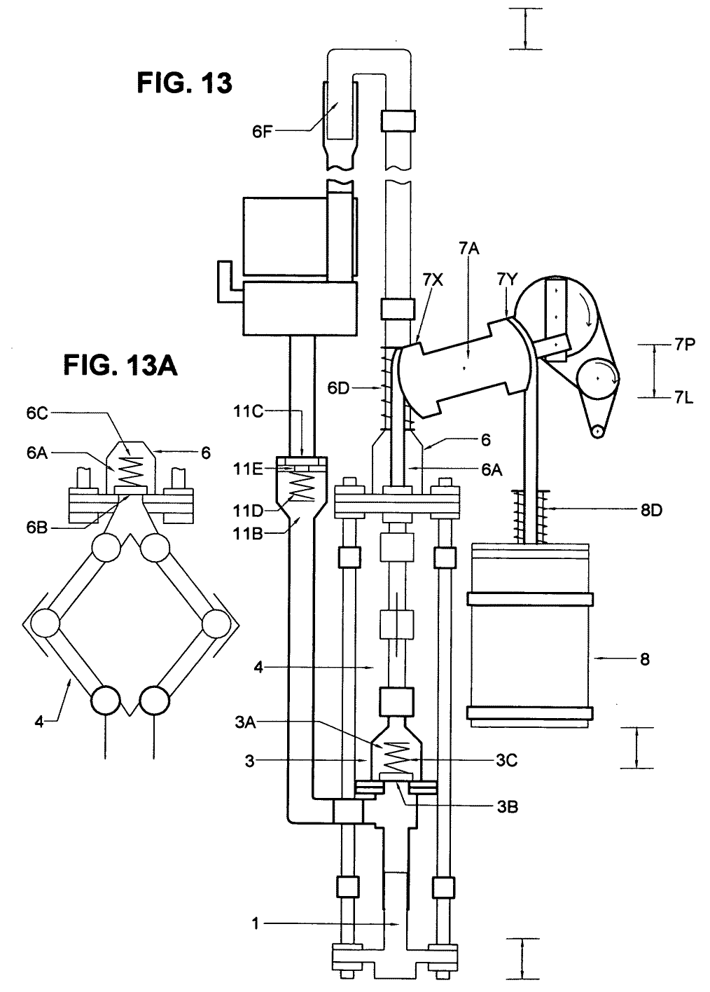

FIG. 13 The End Position of Input/Intake Process (or the Start Position of the Output/Discharge Operation)—depicts the ending position of C-M1 in the Input/Intake Operation.

FIG. 13A The Output Chamber Assembly 6 and the Transit Pipe Assembly 4—depicts the front views of the Output Chamber Assembly 6 and the Transit Pipe Assembly 4 during the end process of the Input/Intake Operation.

### D) Other Drawings

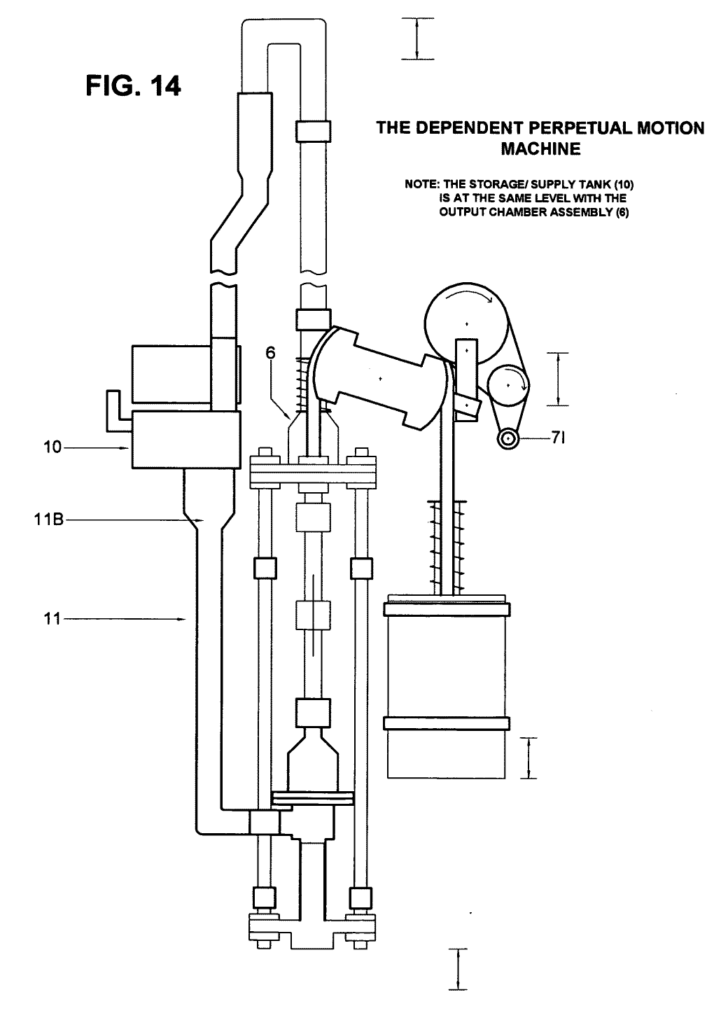

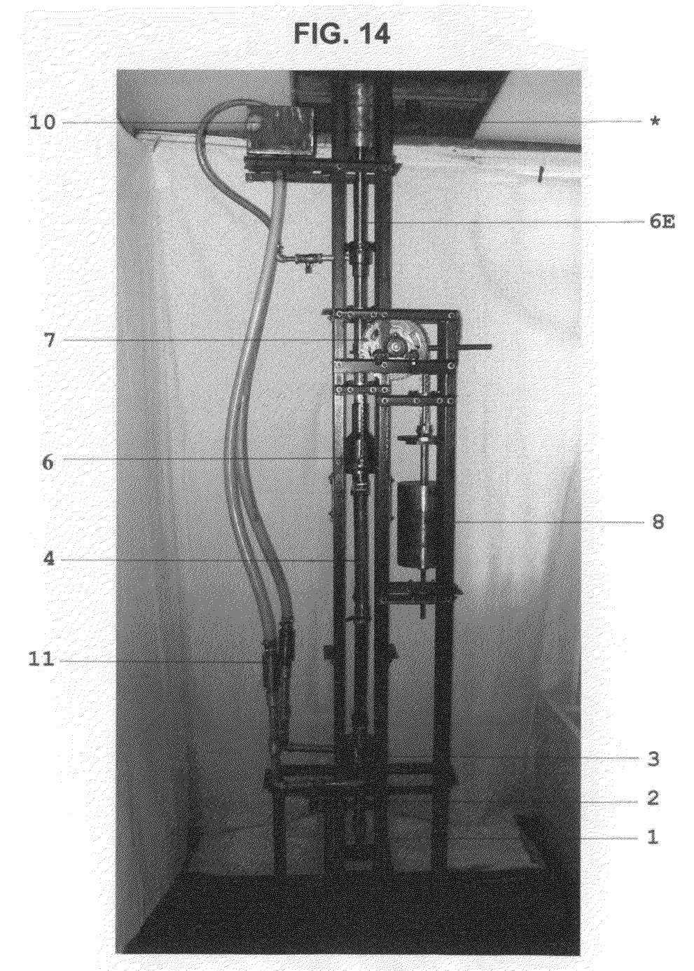

FIG. 14 The Left Side View of The Dependent Perpetual Motion Machine—depicts every part of C-M1 in a side view form The drawing points out the main but simple differences between the two perpetual motion machines and these are the Resistance Weight 8B and Pull Weight 8C, Intake's Weight Compensator 11F and the Intake's Outbalancing Weight 11G, which are applicable only to the Absolute.

FIG. 15 The Picture of C-M1 with Major Parts Labeled—the picture points out and identify the major parts of the machine in relation to C-M1 working model.

### DETAILED DESCRIPTION OF THE INVENTION

In all honesty, C-M1's technical aspect is simple. In fact, in my actual explanation and demonstration to my selected kin on how C-M1 works, I needed only 10 minutes. C-M1 is basic of all basics machine, working primarily on the Techniques and the underlying Principle of Equilibrium. But how does C-M1 handle the Input/Intake and Output/Discharge Operations, the known problem since man has existed? C-M1 has employed simple Techniques that have not been discovered since time immemorial. These techniques are fully described and consolidated in the illustration of C-M1 Embodiments.
A) C-M1 Parts
B) C-M1 Components
C) C-M1 Types of Perpetual Motion Machine
D) C-M1 Operation Defined and Described
E) C-M1 Choice of Presentation
F) C-M1 Housekeeping
G) C-M1 Embodiments
   A) C-M1 Parts—C-M1 is Divided into 11 Major Parts and 44 Subparts:
   1 Piston—draws water from the Storage/Supply Tank 10A down to the Cylinder/Storage Chamber 2 during the Input/Intake Operation, and discharges it to the Discharge Chamber 3A during the Output/Discharge Operation.
   2 Cylinder/Storage Chamber—stores water drawn by the Piston 1 from Storage/Supply Tank 10A down to the Intake Chamber 11B during Input/Intake Operation and releases it to Discharge Chamber 3A during the Output/Discharge Operation.
   3 Discharge Chamber Assembly
      3A Discharge Chamber—receives water that is being pumped out from Cylinder/Storage Chamber 2 and passes it on to the Transit Pipe 4A during the Output/Discharge Operation.
      3B Discharge Valve—closes during Input/Intake Operation and opens during Output/Discharge Operation.
      3C Discharge Valve Spring—a low-tensioned spring designed to push lightly the Discharge Valve 3B, thus, allows the Discharge Valve 3B to open and close easily during the Output/Discharge and Input/Intake Operations respectively.
   4 Transit Pipe Assembly
      Note: Transit Pipe Assembly 4 and Transit Pipe Assembly D of the C-M1 Components may be used interchangeably.
      4A Transit Pipe—the water conduit between the Discharge Chamber 3A and the Output Chamber 6A. The Transit Pipe 4A slowly bends from its upright position during Input/Intake Operation and stretches slowly to an upright position from its angular position during Output/Discharge Operation. These movements are made possible through Cylindrical Joints 4B. The longer the Transit Pipe is and the shorter the Piston 1 travels, the lesser the pumping/water resistance can be during Output/Discharge Operation.
      4B Cylindrical Joints (or Hydraulic Hose)—allow the Transit Pipe 4A to bend during the Input/Intake Operation and stretch while the water is also being discharged simultaneously, during Output/Discharge Operation.
      4C Cylindrical Joint Springs—serve to counter the weight of the Transit Pipe 4, Cylindrical Joints 4B and the water inside the assembly during the Input/Intake and Output/Discharge Operations.
   Push/Pull Rod Assembly
      5A Push/Pull Rod—pushes the Piston 1 downward during Input/Intake Operation and pulls the Piston 1 upward during Output/Discharge Operation. Please note that the Cylinder/Storage Chamber 2 is fixed or immovable. Push/Pull Rod Assembly 5 links the Output Chamber Assembly 6 and the Piston 1 through their flanges.
      5B Push/Pull Rod Guides—guide the up and down movement of Push/Pull Rod 5A.
   6 Output Chamber Assembly
      6A Output Chamber—receives water from the Transit Pipe 4A during Output/Discharge Operation and passes it on to the Output Pipe 6E.
      6B Output Valve—closes during Input/Intake Operation and opens during the Output/Discharge Operation.
      6C Output Valve Spring—a low-tensioned spring designed to push lightly the Output Valve 6B thus, allows the Output Valve 6B to open and close easily during the Output/Discharge and Input/Intake Operations, respectively.
      6D Moving Component Momentum Spring—a calibrated spring enough to counter the momentum of the Counterweight Assembly 8 and Moving Component B during Output/Discharge Operation and to give a push at the start of Input/Intake Operation.
      6E Output Pipe—receives water from the Output Chamber 6A during Output/Discharge Operation and dispatches it to the Output Pipe Feeder 6F.
      6F Output Pipe Feeder—the “U” shape pipe that feeds the discharged water into the Turbine Pipe Funnel 9A.
      6G Output Pipe Guides—guide the up and down movement of the Output Pipe 6E.
   7 Lever Assembly
      7A Lever—holds Moving Component B on Lever's 7A End 7X and the Counterweight Assembly 8 on Lever's 7A End 7Y through Chain/Cable 7B connection. It is in itself perfectly balanced.
      7B Chain/Cable—Connects the Lever 7A to Moving Component B on Lever's 7A End 7X and the Counterweight Assembly 8 on Lever's 7A End 7Y.
      7C Lever Handle—attaches to the Connecting Rod 7E.
      7D Fly Wheel—stabilizes the revolution or speed of the C-M1.
      7E Connecting Rod—connects the Crank Shaft 7F and the Lever Handle 7C.
      7F Crank Shaft—drives the Lever Handle 7C by means of Connecting Rod 7E in up and down movements.
      7G Electric Motor RS—a low speed a/c motor designed to control the revolution or speed of the C-M1 and not as a prime mover.
      7H Pulley Intermediate and Belts—link the Electric Motor RS 7G and Fly Wheel 7D.
      7I Electric Motor PM (Applicable only to Dependent Perpetual Motion Machine)—drives the Crank Shaft and serves as C-M1's prime mover.
      7X End—the tip or end of the Lever 7A where the whole Moving Component B is attached by means of Chain/Cable 7B.
      7Y End—the tip or end of the Lever 7A, where the whole Counterweight Assembly 8 is attached by means of Chain/Cable 7B.
      7P High Point—the highest point of travel by the Lever Handle 7C in an upward direction.
      7L Low Point—the lowest point of travel by the Lever Handle 7C in a downward 20 direction.
   8 Counterweight Assembly
      Note: Counterweight Assembly 8 and Counterweight Assembly C may be used interchangeably.
      8A Balancing Weight—equalizes the total weight of the Moving Component B and the water inside the system that is from the tip of the Piston 1 all the way to the tip of the Output Pipe 6E.
      8B Resistance Weight—the weight needed to overcome the resistance.
      8C Pull Weight—the weight needed to pull the Lever's 7A End 7Y in a downward direction so as to perform the Output/Discharge Operation. The weight of the Pull Weight 8C is calculated based on the speed (cycle per minute) requirements of C-M1. Therefore, the heavier the Pull Weight 8C is, the faster the Output/Discharge Operation can be. These 8B and 8C of the Counterweight Assembly 8 are counter balanced by Intake Chamber Assembly's 11 Weight Compensator 11F and are applicable only to Absolute Perpetual Motion Machine.
      8D Counterweight Momentum Spring—a calibrated spring enough to counter the momentum of the Counterweight Assembly 8 and Moving Component B during the Input/Intake Operation and to push at the start of the Output/Discharge Operation.
      8E Counterweight Guides—guide the up and down movement of the Counterweight Assembly 8.
   9 Electric Generating Assembly
      9A Turbine Pipe Funnel—ensures air ventilation and prevents water spillage while the Output Pipe Feeder 6F is moving up and down.
      9B Turbine Pipe—receives water coming from the Output Pipe Feeder 6F, which will be used to drive the Turbine 9C.
      9C Turbine—receives water from the Turbine Pipe 9B, which makes the Turbine 9C turn and drive the Electric Generator 9D, then release the water into the Storage/Supply Tank 10A.
      9D Electric Generator—produces electricity.
   10 Storage/Supply Tank Assembly
      10A Storage/Supply Tank—receives and stores water coming from the Turbine 9C and releases it to the Intake Chamber 11B during Input/Intake Operation.
      10B Storage/Supply Tank Vent—provides air ventilation during the receiving of water from Turbine 9C and the supplying of water to the Intake Chamber 11B.
   11 Intake Assembly
   11A Intake Pipe—receives water from the Intake Chamber 11B and delivers it to the Cylinder/Storage Chamber 2 during Input/Intake Operation. Significantly the weight of the water inside the Intake Pipe 11A will be used to replace the equivalent weight of the water in the Transit Pipe Assembly 4, which is stagnant during the Input/Intake Operation.
      11B Intake Chamber—receives water from the Storage/Supply Tank 10A and passes it on to the Intake Pipe 11A during Input/Intake Operation.
      11C Intake Valve—opens during Input/Intake Operation and closes during Output/Discharge Operation.
      11D Intake Valve Spring—a low-tensioned spring designed to push lightly the Intake Valve 11C, thus, allows the Intake Valve 11C to open and close easily during the Input/Intake and Output/Discharge Operations respectively.
      11E Intake Valve Lock—this solenoid mechanism locks the Intake Valve 11C during the Output/Discharge Operation and unlocks it during the Input/Intake Operation.
      11F Intake's Weight Compensator—the weight of water that will be used to compensate the Resistance Weight 8B and the Pull Weight 8C of the Counterweight Assembly 8.
      11G Intake's Outbalancing Weight—the weight needed to outweigh the whole Counterweight Assembly 8 and the weight needed to perform the Input/Intake Operation with the same speed (cycle per minute) as of that of the Output/Discharge Operation. This portion of the Intake Assembly 11 is required only in the Absolute Perpetual Motion Machine.
      Option: Intake Assembly 11 can be part of the Moving Component B. It can be placed adjacent to Output Chamber Assembly 6.
   B) C-M1 Components—C-M1 is classified into 4 major components. They will simplify the understanding on how the machine works. These classifications, which are the Techniques of the Invention, are the objects of the Claims Section of the Specification. Without these Components combination, C-M1 will not run.
      A Non-moving Component (represented by bold line)—this classification is composed of 6 major non-moving parts. Although the Lever 7A, Connecting Rod 7E and Crankshaft 7F move in up and down motions, the whole Lever Assembly 7 and Electric Motor RS 7G or Electric Motor PM 7I (applicable only to Dependent Perpetual Motion Machine) do not move. They are fixed on their bases and are not subject to counterweights of the Counterweight Assembly 8.

| Assembly/Part No. | Description |
|---|---|
| 2 | Cylinder/Storage Chamber |
| 3 | Discharge Chamber Assembly |
| 7 | Lever Assembly |
| 9 | Electric Generating Assembly |
| 10 | Storage/Supply Tank |
| 11 | Intake Assembly |

B Moving Component (represented by thin line)—this classification is composed of 3 major parts that move in up and down motions dependent on Lever's 7A End 7X travel during Input/Intake and Output/Discharge Operations. This Component is the object of Balancing Weight 8A of the Counterweight Assembly 8. The weight of the Moving Component and the water inside the system (that is from the tip of the Piston 1 all the way to the tip of the Output Pipe 6E) is equal to the weight of Balancing Weight 8A.

| Assembly/Part No. | Description |
|---|---|
| 1 | Piston |
| 5 | Push/Pull Rod Assembly |
| 6 | Output Chamber Assembly |
| * | Water (is not a Machine Part but included in the |
| | weight) |

C Counterweight Assembly—this classification is composed of only 1 major part. Its function is to equalize the total weight of the Moving Component B and the water inside the system that is, from the tip of the Piston 1 all the way to the tip of the Output Pipe 6E; to provide weight that will overcome the resistance; and finally, to provide the weigh needed by the Pull Weight 8C to perform the Output/Discharge Operation.

| Assembly/Part No. | Description |
|---|---|
| 8 | Counter Weight Assembly |

D Transit Pipe Assembly—this classification is composed of only 1 major part. Its usage and purpose is unprecedented. It is flexible, and serves as the transit point of the discharged water from the Discharge Chamber 3A going to the Output Chamber Chamber 6A.

| Assembly/Part No. | Description |
|---|---|
| 4 | Transit Pipe Assembly |

### C) C-M1 Types of Perpetual Motion Machine

1 Absolute Perpetual Motion Machine—we at CIT define it as a perpetual motion machine that runs without the need or aid of a prime mover—the electric motor. Outbalancing/Outweighing Approach—The process of outweighing the Moving Component B by Counterweight Assembly 8 during Output/Discharge Operation and outweighing Counterweight Assembly 8 by the Moving Component B with the aid of the weight of the water coming from the Intake's Outbalancing Weight 11G all the way down to the tip of the Piston 1 during the Input/Intake Operation. In this approach, the water level of the Intake's Weight Compensator 11F and Intake's Outbalancing Weight 11G must be higher than the Output Chamber 6A wherein the End 7X and Moving Component B are at the highest point of travel and the Transit Pipe 4A is in full stretch. The weight of that height difference is computed: first, to outweigh the Counterweight Assembly 8 and second, to push down the Moving Component B through the Piston 1 with the same speed (cycle per minute) with Pull Weight 8C during the Output/Discharge Operation. This approach has led to the discovery of what we now call the Absolute Perpetual Motion Machine.
2 Dependent Perpetual Motion Machine—we at CIT define it as a perpetual motion machine that runs with the need or aid of a prime mover—the electric motor. Perfect Balance Approach—C-M1 works basically on the principle of equilibrium. In this approach, the weight of the Moving Component B and the Counterweight Assembly 8 as a whole are the same, the height of Intake Chamber 11B is at level with Output Chamber's 6A base where the End 7X and Moving Component B are at the highest point of travel, and the Transit Pipe 4A is in full stretch. Also in this approach, the weights of the Resistance 8B and the Pull Weight 8C and Intake's Outbalancing Weight 11G and Intake's Weight Compensator are not employed. This resulted to the discovery of what we call the Dependent Perpetual Motion Machine. The purpose of a prime mover is to overcome the resistance and to provide power to run the required speed of the machine.
3 Differences Between The Absolute and Dependent Perpetual Motion Machines Actually, there are only four minor differences between the two machines' structure, and these are the Intake's Weight Compensator 11F and Intake's Outbalancing Weight 11G and the Resistance Weight 8B and Pull Weight 8C in the Absolute, which are not present in the Dependent. As a result, Absolute's structure is higher than the Dependent, and has a heavier Moving Component B and Counterweight Assembly 8.

### D) C-M1 Operation Defined and Described

1 Input/Intake Operation—the process where the Piston 1 draws water from the Storage/Supply Tank 10A which passes through the Intake Assembly 11 and finally stores it in the Cylinder/Storage Chamber 2. In this process, the Intake Valve 11C opens while the Discharge Valve 3B and Output Valve 6B close, and the weight of the water inside the Transit Pipe Assembly 4 is no longer part of the Moving Component B weight, but the weight of the water inside the Intake Chamber 11B and Intake Pipe 11A take its place instead. The Moving Component B and the End 7X of the Lever 7A travel in a downward direction while the End 7Y of the Lever 7A and Counterweight Assembly 8 travel in an upward direction.
2 Output/Discharge Operation—the process where the Piston 1 discharges the water from the Cylinder/Storage Chamber 2 to the Discharge Chamber 3A, Transit Pipe 4, Output Output Chamber 6A and finally, to the Turbine Pipe 9B. In this process, the Discharge Valve 3B and Output Valve 6B open while the Intake Valve 11C closes and the weight of the water inside the Transit Pipe 4A becomes part of the weight of the Moving Component B. The Moving Component B and the End 7X of the Lever 7A travel in an upward direction while the End 7Y of the Lever 7A and Counterweight Assembly 8 travel in a downward direction.

### E) C-M1 Choice of Presentation

1 Preference
1-1 Absolute Perpetual Motion Machine—of the two types of perpetual motion machine, we prefer the Absolute Perpetual Motion Machine in our presentation.
1-2 Output/Discharge Operation—although we can use either Output/Discharge Operation or Input/Intake Operation as the start of operation, we just simply choose the former. Take note that the Moving Component B and End 7X of the Lever 7A are in the lowest point of travel position and End 7Y of the Lever 7A and Counterweight Assembly 8 are in the highest point of travel position while the Transit Pipe 4A is in bended or angular position. Please refer to FIGS. 8 and 8A.

### F) C-M1 Housekeeping

1 Calibration/Preparation
1-1 Counterweight Momentum Spring 8D—although optional at the start of operation, this spring can be compressed so it can be used to push (downward direction that is from Point 7P to Point 7L of the Lever 7A) the Counterweight Assembly 8 as a whole to initially start the Output/Discharge Operation.
1-2 After the Counterweight Assembly 8 is counterbalanced by the weights of the water inside Intake Pipe 11A, Intake Chamber 11B and Intake's Weight Compensator; and after the area and the height of Intake's Outbalancing Weight 11G has been calculated according to the desired speed (cycle per minute), C-M1 is now ready for priming.
   Note: the weights of Intake's Outbalancing Weight 11G and Pull Weight 8C are more less the same. During the Input/Intake Operation the weight of water inside the Transit Pipe Assembly 4 is stagnant and being replaced by the weights of water inside the Intake Pipe 11A and Intake Chamber 11B.
2 Priming
   2-1 Water—C-M1 needs priming. Except the Turbine Pipe 9B, if preferred, the whole machine—that is from the Storage/Supply Tank 10A down to the Cylinder/Storage Chamber 2 and all the way to the tip of Output Pipe 6E, must be filled with water before it can start operating. Once priming is done, C-M1 is ready for operation.

### G) C-M1 Embodiments

With most, if not all of C-M1's significant coined terminologies have been defined and their function described, I believe that with the aid of drawings and the Power Point (CD), the understanding how C-M1 works will be made even simpler and easier. Please note that the Start Position of Output/Discharge Process drawing FIG. 8 and the End Position of Input/Intake Process FIG. 13 are exactly the same. Likewise the End Position of Output/Discharge Process FIG. 10 and the Start Position of Input/Intake Process FIG. 11 are also exactly the same. Although there is a sort of drawing duplication, the objective is to show clearly a complete process that is from the start to end on both Input/Intake and Output/Discharge Operations. There are also similarities between the drawings of the Output/Discharge Process FIG. 9 and the Input/Intake Process FIG. 12. However there is a big difference between the two, which is their valves positioning.
Please note that only the following 5 parts have cutaways: 1) Cylinder/Storage Chamber 2—to expose the Piston 1; 2) Discharge Chamber Assembly 3—to expose the Discharge Valve 3B and Discharge Valve Spring 3C; 3) Output Chamber Assembly 6—to expose the Output Valve 6B and Output Valve Spring 6C; 4) Turbine Pipe Funnel 9A—to expose the Output Pipe Feeder 6F; and 5) the Intake Assembly 11—to expose the Intake Valve 11C, Intake Valve Lock 11E and Intake Valve Spring 11D. These cutaway parts are significant to understanding the C-M1's operation. Please note further that the Non-moving Components A is represented by bold line and the Moving Component B is represented by thin line.
1 The Output/Discharge Operation
   This operation is the pumping out of water from the Cylinder/Storage Chamber 2 all the way to the Output Pipe Feeder 6F and, finally, to the Turbine Pipe Funnel 9A. Please refer to FIGS. 8, 9 and 10.
   1-1 FIG. 8 The Start Position of the Output/Discharge Process
      Intake Valve Lock 11E—locks the Intake Valve 11C.
      Valves—Discharge Valve 3B and Output Valve 6B open, Intake Valve 11C closes.
      Moving Component Momentum Spring 6D—is fully decompressed.
      Direction—The End 7Y of the Lever 7A and Counterweight Assembly 8 start traveling downward. The End 7X of the Lever 7A, Moving Component B and the Water from the tip of the Piston 1 all the way to the tip of the Output Pipe 6E, start traveling upward. Water from the Storage/Supply Tank 10A all the way down to the Intake Pipe 11A is still.
      Counterweight Momentum Spring 8D—starts decompression.
      Transit Pipe Assembly 4—starts stretching.
   1-2 FIG. 9 The Output/Discharge Process
      Intake Valve Lock 11E—locked the Intake Valve 11C.
      Valves—Discharge Valve 3B and Output Valve 6B open fully; Intake Valve 11C Closed.
      Moving Component Momentum Spring 6D—is now being compressed.
      Direction—The End 7Y of the Lever 7A and Counterweight Assembly 8 are now traveling downward. The End 7X of the Lever 7A, Moving Component B and the water from the tip of the Piston 1 all the way to tip of the Output Pipe 6E are now traveling upward while concurrently the water is also being unloaded into the Turbine Pipe Funnel 9A. Water from the Storage/Supply Tank 10A all the way down to the Intake Pipe 11A is inactive.
      Counterweight Momentum Spring 8D—is being decompressed.
      Transit Pipe Assembly 4—is now stretching.
   1-3 FIG. 10 The End Position of the Output/Discharge Process
      Intake Valve Lock 1 E—still locked the Intake Valve 11C.
      Valves—Discharge Valve 3B and Output Valve 6B close, Intake Valve 11C remains closed.
      Moving Component Momentum Spring 6D—is fully compressed.
      Direction—The End 7Y of the Lever 7A and Counterweight Assembly 8 travel downward end. The End 7X of the Lever 7A, Moving Component B and water from the tip of the Piston 1 all the way to tip of the Output Pipe 6E traveling upward end. Water from the Storage/Supply Tank 10A all the way down to the tip of the Intake Pipe 11A remains inactive.
      Counterweight Momentum Spring 8D—is fully decompressed.
      Transit Pipe Assembly 4—is fully stretched.
2 The Input/Intake Operation
   This operation is the supplying of water from Storage/Supply Tank 11A all the way down to the Cylinder/Storage Chamber 2. Please refer to FIGS. 11, 12 and 13.
   2-1 FIG. 11 The Start Position of the Input/Intake Process
      Intake Valve Lock 11E—unlocks the Intake Valve 11C.
      Valves—Intake Valve 11C opens; Discharge Valve 3B and Output Valve 6B close.
      Moving Component Momentum Spring 6D—starts decompression.
      Direction—The End 7Y of the Lever 7A and the Counterweight Assembly 8 start traveling upward. The End 7X of the Lever 7A and Moving Component B start traveling downward. The water from the Discharge Chamber 3A all the way to the tip of the Output Pipe 6E is still. Water from the Storage/Supply Tank 10A all the way down to the Intake Pipe 11A starts flowing downward to fill up the Cylinder/Storage Chamber 2.
      Counterweight Momentum Spring 8D—is fully decompressed.
      Transit Pipe Assembly 4—starts bending.
   2-2 FIG. 12 The Input/Intake Process
      Intake Valve Lock 11 E—unlocked the Intake Valve 11C.
      Valves—Intake Valve 11C opens fully, Discharge Valve 3B and Output Valve 6B close.
      Moving Component Momentum Spring 6D—is being decompressed.
      Direction—The End 7Y of the Lever 7A and Counterweight Assembly 8 are now traveling upward. The End 7X of the Lever 7A and Moving Component B are now traveling downward. The water from the Discharge Chamber 3A all the way to tip of the Output Pipe 6E is inactive. Water from the Storage/Supply Tank 10A all the way down to the Intake Pipe 11A is now flowing downward filling up the Cylinder/Storage Chamber 2.
      Counterweight Momentum Spring 8D—is now being compressed.
      Transit Pipe Assembly 4—is now bending.
   2-3 FIG. 13 The End Position of the Input/Intake Process
      Intake Valve Lock 11E—still unlocked the Intake Valve 11C.
      Valves—Intake Valve 11C closes; Discharge Valve 3B and Output Valve 6B remain closed.
      Moving Component Momentum Spring 6D—is fully decompressed.
      Direction—The End 7Y of the Lever 7A and Counterweight Assembly 8 travel ends. The End 7X of the Lever 7A and Moving Component B travel ends. Water from the Discharge Chamber 3A all the way to the tip of the Output Pipe 6E remains inactive. Water from the Storage/Supply Tank 10A all the way down to the Intake Pipe 11A flow downward ends.
         Cylinder/Storage Chamber 2 is full.
      Counterweight Momentum Spring 8D—is fully compressed.
      Transit Pipe Assembly 4—is fully bent.

### Important Notice

The main objective in depicting Cangrier-M1 Machine or C-M1 in a Power Point Environment is to show the four major components' function and coordination during the Input/Intake and Output/Discharge Operations. Please note that minor parts are not included in the presentation.

### The Four Major Components:

1. The Non-Moving Component
2. The Moving Component
3. The Counterweight Assembly
4. The Transit Pipe Assembly

1- Claims On Types Of Perpetual Motion Machine's Techniques And Workability
A The Absolute Perpetual Motion Machine
1 It is employing the outweighing/outbalancing concept.
2 It has Balancing Weight 8A, Resistance Weight 8B and Pull Weight 8C that outweigh or outbalance the total weight of the Moving Component B during the Output/Discharge Operations.
3 It has an Intake's Outbalancing Weight 11G that outweighs or out balances the total weight of the Counterweight Assembly 8 during the Input/Intake Operation.
4 With the aforementioned outweighing/outbalancing weights, C-M1 will run without the need of a prime mover—Electric Motor PM 7I.
5 Its Storage/Supply Tank 10A location is designed to be higher than the Output Chamber Assembly 6 when the Transit Pipe 4A is in the full stretched position.
6 If an Electric Motor RS 7G is used, which is advisable, its function is to maintain and control the speed and smoothness of the machine's RPM, but not as a prime mover.
B The Dependent Perpetual Motion Machine
7 It is totally adapting the principle of equilibrium or perfect balance approach where the weights of the Counterweight Assembly 8 (less Resistance Weight 8B and Pull Weight 8C) and the Moving Component B are perfectly equal.
8 It has no Resistance Weight 8B and Pull Weight 8C and Intake's Outbalancing Weight 11G and Intake's Weight Compensator 11F and therefore it is not employing the outweighing/outbalancing concept, which are crucial components of Absolute Perpetual Motion Machine.
9 The water level in the Storage/Supply Tank 10A location is in level with the Output Chamber Assembly 6 when the Transit Pipe 4A is in the full stretched position.
10 It requires Electric Motor PM 7I to overcome the resistance and to maintain the prescribed RPM of C-M1.
C Difference Between The Absolute and The dependent Perpetual Motion Machines
11 Logically and technically there are only four simple differences between the two machines and these are the Intake's Weight Compensator 11F, Intake's Outbalancing Weight 11G and the Resistance Weight 8B and Pull Weight 8C, which are applicable only to Absolute (Please refer to FIGS. 2 and FIG. 3).

2- Claims On Components/Parts. Techniques And Workability
D The Non-moving Component
12 It has 6 major non-moving parts namely: Cylinder/Storage Chamber 2, Discharge Chamber Assembly 3, Lever Assembly 7, Electric Generating Assembly 9, Storage/Supply Tank 10 and Intake Assembly 11.
13 Although the Lever 7A and Crankshaft 7F move in up and down motions, the entire Lever Assembly 7 and the Electric Motor RS 7G (and Electric Motor PM 7I, applicable only to Dependent Perpetual Motion Machine) do not move since they are fixed on their bases and are not subject to any counterweights.
E The Moving Component B
14 It has 3 major moving parts namely: Piston 1, Push/Pull Rod Assembly 5, Output Chamber Assembly 6, and although not a machine part, water is included.
15 It moves in up and down motions dependent on Lever's 7A End 7X travel during the Input/Intake and Output/Discharge Operations.
16 The total weight of Moving Component B and the water inside (that is from the tip of the Piston 1 all the way up to the tip of the Output Pipe 6E) is equal to the weight of the Balancing Weight 8A of the Counterweight Assembly 8.
F The Counterweight Assembly C (or 8)
17 It is composed of only 1 major part The Counterweight Assembly 8.
18 Its foremost function is to equalize the total weight of the Moving Component B and the water inside the system that is, from the tip of the Piston 1 all the way to the tip of the Output Pipe 6E by the weight of the Balancing Weight 8A.
19 It provides the weight needed by Resistance Weight 8B to overcome the resistance and the weight needed by the Pull Weight 8C to perform the desired speed during the Output/Discharge Operation (applicable only to Absolute Perpetual Motion Machine).
G The Transit Pipe Assembly D (or 4)
20 It is composed of only 1 major part The Transit Pipe Assembly 4.
21 This unprecedented part bends, stretches, and serves as the transit point of the discharged water from the Discharge Chamber 3A going to Output Chamber 6A.
I The Components Combination
22 The combination of Components' functions and workability are the Techniques that resulted to the Invention of C-M1.

3- Claims on The Power of C-M1
J The Power Of C-M1
23 Since it works on the Techniques (the invention) and the underlying Principle of Equilibrium or perfect balance, pumping out 1 cubic meter of water per stroke through a 1.6-meter diameter 500-meter high pipe, with a total water weight of 1,000 tons or pumping out 70 cc of water per stroke through a 2.6-centimeter diameter 32-meter high pipe, with a total water weight of 16.8 kilos, is practically the same easy job for C-M1.

4- Claims on Other Usage of C-M1 as Prime Mover Based on the Same Drawings and Specification
K Other Application (Non Electric Power Generation)
24 It can be used to pump out water to supply water to urban and rural areas, irrigation, cooling system for centralized air conditioning and other industrial applications, fire fighting; for pumping out water for flood control; to run elevators, cable cars, conveyors; and many more.
L C-M1 Hydro and C-M1 Hydraulic
25 By adapting the principle of hydraulic and by using steel weights instead of water, Output Pipe 6E can be eliminated (Please refer to C-M1 Picture which is FIG. 1.
26 There are only two minor differences between the C-M1 hydro (using water) and C-M1 hydraulic and they are: 1) C-M1 hydro uses Output Pipe 6E while C-M1 hydraulic does not; 2) C-M1 hydro does not have check valve since it is free flow, while C-M1 hydraulic may have check valve which is closed during and opens immediately after the Output/Discharge Operation.
